(19) United States
(12) Patent Application Publication
(10) Pub. No.: US 2015/0324461 A1
(43) Pub. Date: Nov. 12, 2015

(54) Data Query of a Peer Device

(71) Applicant: Motorola Mobility LLC, Chicago, IL (US)

(72) Inventors: Sujoy Das, Grayslake, IL (US); Jagadish K. Agrawal, Santa Clara, CA (US); Jordan Andrew Hurwich, Palo Alto, CA (US)

(73) Assignee: Motorola Mobility LLC, Chicago, IL (US)

(21) Appl. No.: 14/273,929

(22) Filed: May 9, 2014

(51) Int. Cl. G06F 17/30; H04L 29/08

(52) U.S. Cl. CPC G06F 17/30864; H04L 67/104; H04L 67/141

(57) ABSTRACT

In embodiments for data query of a peer device, a peer device implements a peer communication manager that monitors for a broadcast message with keywords that are broadcast by a requesting peer device. The keywords are usable by a peer data manager of the peer device to search for content items of shareable content that is stored on the peer device and designated as shareable. The shareable content can be searched to generate metadata that describes the shareable content items that correspond to the keywords received from the requesting device. The peer device can then establish a communication link with the requesting device via which the generated metadata is communicated to the requesting device. The requesting device can then request one or more of the shareable content items based on the generated metadata, and receive the shareable content items from the peer device.

### BACKGROUND

Low-cost, high density memory devices enable users to store large quantities of content on their computing devices, such as mobile phones, portable computers, tablet devices, and other similar devices. Multiple forms of connectivity also allow the devices to acquire and share content with other users and their devices. However, as content libraries grow in size, searching through a shared library on a device to find content of interest becomes an increasingly laborious task. Also, as computing devices are increasingly mobile, the availability of shareable content libraries ebbs and flows as devices come into and out of range for communication. For instance, a user might initiate a search from his or her device for music content in a library on another device that is currently within proximity to the user, but not be able to find items of interest. However, a short time later, other devices may come in range that have the music content of interest to the user. For the user to find this content on the later arriving devices, the user would need to continuously perform searches to find available devices and their associated libraries of shareable content. Additionally, a user might want to look at the available libraries of the sharable content in various ways, such as by artist, title, or genre, or a combination of search terms describing the content they desire to find on other devices.

### BRIEF DESCRIPTION OF THE DRAWINGS

Embodiments of data query of a peer device are described with reference to the following Figures. The same numbers may be used throughout to reference like features and components that are shown in the Figures:

FIG. 1 illustrates an example system in which embodiments of data query of a peer device can be implemented.

FIG. 2 illustrates another example system in which embodiments of data query of a peer device can be implemented.

FIG. 3 illustrates an example method for data query of a peer device in accordance with one or more embodiments.

FIG. 4 illustrates another example method for data query of a peer device in accordance with one or more embodiments.

FIG. 5 illustrates various components of an example electronic device that can implement embodiments of data query of a peer device.

### DETAILED DESCRIPTION

Embodiments of data query of a peer device are described for various forms of computing devices, such as a mobile phone or tablet device, a computer, or a mobile hotspot. A computing device may be any form of device that has storage for content and the capability to communicate with other devices, to either share the content, or search for content on a peer device. Further, the computing device may support the ability of a user to enter keywords as a basis to search content libraries in various ways, and to broadcast those keywords to any peer devices that are in proximity and able to receive the keyword broadcast. When a peer device receives the keyword broadcast, the peer device uses the keywords to search shareable content stored on the peer device and generate metadata describing the shareable content that, in some manner, matches or is related to the keywords received in the keyword broadcast. The peer device may then establish a communication link with the requesting device, to either communicate the generated metadata if content items that correspond to the keywords are found, or to send a response indicating that no items of shareable content correspond to the broadcast keywords. If related or matching content is found, the user and/or the requesting device can then decide whether or not to access the content on the peer device referenced by the metadata.

A requesting peer device can broadcast the keywords to multiple peer devices that are in proximity, enabling any of the peer devices to independently search shareable content and provide the requesting device with search results from multiple content libraries stored on the peer devices. A user of the requesting device can establish a contextual parameter for broadcasts of the keywords, based on the context of the user's computing device, such as by broadcasting different sets of keywords based on location, time of day, or other contextual factors.

In implementations, the shareable content is a portion of content stored on a computing device (e.g., a peer device) that has been designated as being shareable with other peer devices. A peer search manager implemented by the computing device receives keywords as input from a user, and the keywords are broadcast to the peer devices. A peer communication manager implemented by the computing device manages broadcasting the keywords and also communicating metadata and content between the computing device and the other peer devices using communication transceivers. The broadcast keywords received at a peer device in a broadcast message from the computing device are processed by a peer data manager that is implemented by the peer device. The peer data manager searches the shareable content stored on the peer device using the broadcast keywords to generate the metadata that describes attributes of the shareable content items that match, correspond, or are related to the keywords. The generated metadata describes any content items in the shareable content that correspond to the received keywords, and the generated metadata can then be communicated from the peer device to the requesting computing device.

While features and concepts of data query of a peer device can be implemented in any number of different devices, systems, networks, and/or configurations, embodiments of data query of a peer device are described in the context of the following example devices, systems, and methods.

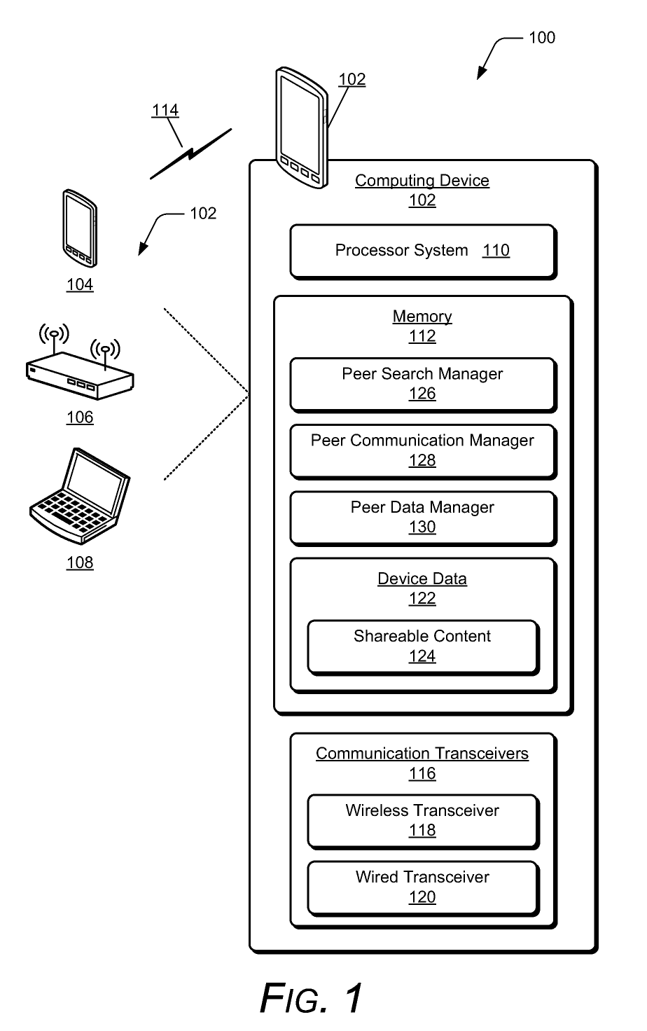

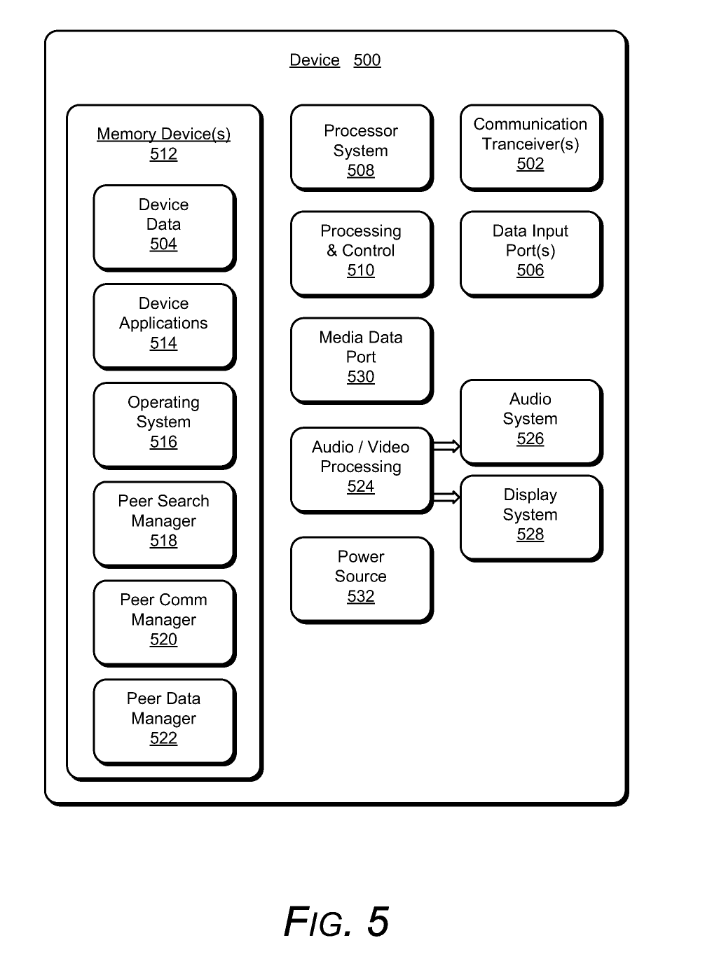

FIG. 1 illustrates an example system 100 in which embodiments of data query of a peer device can be implemented. The example system 100 includes a computing device 102, such as a mobile device 104, a mobile hotspot 106, or a computer 108. The computing device 102 may be any type of wired or wireless electronic and/or computing device, such as a mobile phone, tablet computer, handheld navigation device, portable gaming device, media playback device, or any other type of electronic and/or computing device. Generally, any of the devices described herein can be implemented with various components, such as a processing system 110 and memory 112, as well as any number and combination of differing components as further described with reference to the example device shown in FIG. 5.

As described herein, any of the computing devices may each be a peer device and can be connected via a network 114, such as over a peer-to-peer network, to other peer devices. The network can be implemented to include a wired and/or a wireless network. The network can also be implemented using any type of network topology and/or communication protocol, and can be represented or otherwise implemented as a combination of two or more networks, to include IP-based networks and/or the Internet. The network may also include mobile operator networks that are managed by a mobile network operator and/or other network operators, such as a communication service provider, mobile phone provider, and/or Internet service provider.

The computing device 102 may include any suitable type of communication transceivers 116, including a wireless transceiver 118 for communication via a wireless network (e.g., a mesh network) and/or a wired transceiver 120 for wired communication. The wireless transceiver 118 may be any type of transceiver configured to communicate via a wireless network, such as a wireless wide-area network (WWAN), a wireless local-area network (WLAN), and a wireless personal-area network (wireless PAN), each of which may be configured in part or entirely as infrastructure, ad-hoc, or mesh networks. For example, the wireless transceiver 118 can be implemented as a short-range wireless transceiver to communicate over a wireless personal-area-network (PAN) in accordance with a Bluetooth™ and/or Bluetooth™ low energy (BLTE) protocol. The Bluetooth™ family of protocols support various communication profiles for communicating various types of data and/or enabling different feature sets between devices connected for communication via a wireless PAN.

The Bluetooth™ and/or BLTE family of protocols also support “pairing” between devices, which may enable the computing device 102 to associate with other peer devices. When initially pairing with another device, the computing device 102 can store self-identifying information (e.g., a medium access control (MAC) address) associated with the other device in an information table (e.g., a pairing table) for future use. The information table can also store a context associated with the other device, such as an identity of a user, a mode of use for the computing device 102, and/or a location of the other device. For example, the computing device 102 may communicate with a peer device that has shareable content and is within proximity whenever the wireless transceiver 118 using Bluetooth™ is able to communicate with the paired peer device. Alternatively, the wireless transceiver may be implemented for near-field communication (NFC), to enable NEC with the peer device, in accordance with various NEC standards, such as ISO 18000-3, ISO/IEC 18092, ECMA-340, ISO/IEC 21481, and ECMA 352, just to name a few.

The computing device 102 includes the wired transceiver 120 that may include wired data interfaces for communicating with other devices, such as an Ethernet transceiver, serial data interface, audio/video port (e.g., high-definition multimedia interface (HDMI) port), or universal serial bus (USB) port. These wired data interfaces may be implemented using standard connectors or through the use of proprietary connectors and associated cables providing enhanced security or interconnect density.

The computing device 102 includes device data 122 that may include shareable content 124, which is maintained in the memory 112 on the device and designated as shareable, such as by a user of the computing device. The shareable content 124 can include any content items that may be shareable between the devices, such as music, documents, emails, contacts, applications, and any other type of audio, video, and/or image data. Alternatively or in addition, the device data 122 may include other device and/or user data that is not shareable.

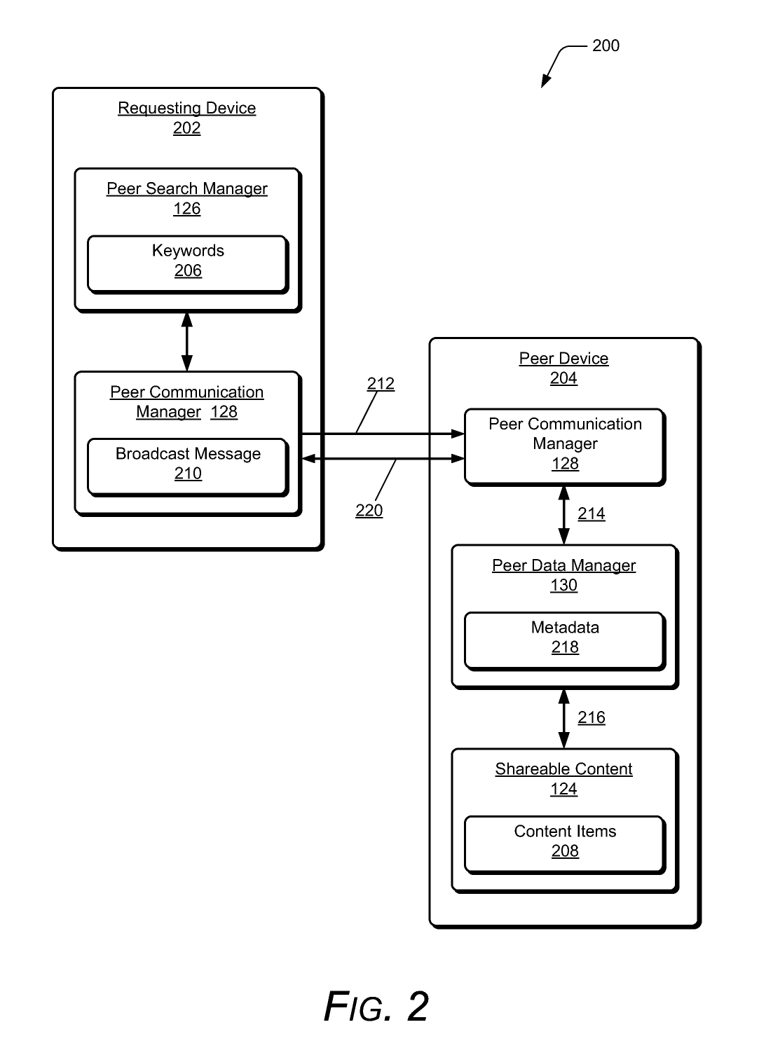

The computing device 102 also includes device applications that implement embodiments of data query of a peer device. In this example, the computing device includes a peer search manager 126, a peer communication manager 128, and a peer data manager 130 that can be implemented as software applications or modules (e.g., computer-executable instructions) stored on computer-readable storage memory, such as any suitable memory device or electronic data storage (e.g., the memory 112), and executed with the processing system 110. Although shown and described as separate manager modules, any one or combination of the peer search manager 126, peer communication manager 128, and peer data manager 130 can be implemented together as a single software application or module. Implementations and functions of the manager modules are further described with reference to FIGS. 2-4.

FIG. 2 illustrates an example system 200 with examples of the computing device 102 implemented as peer devices, such as a requesting device 202 and a peer device 204 that may each be implemented as any of the devices described with reference to FIG. 1. In this example, the requesting device 202 is shown to implement the peer search manager 126 and a first instance of the peer communication manager 128. The peer device 204 is shown to implement a second instance of the peer communication manager 128 and the peer data manager 130. In practice, however, both the requesting device and the peer device can each implement the peer search manager 126, the peer communication manager 128, and the peer data manager 130, as described with reference to the computing device 102 shown in FIG. 1.

The peer search manager 126 at the requesting device 202 is implemented to receive inputs in the form of keywords 206, such as from a user of the device. The keywords represent search terms for the attributes of content that the user is interested in finding or locating on other peer devices, such as con ent items 208 of the sharable content 124 on the peer device 204. The keywords 206 may relate to various attributes of content, for example a composer, a performer, a genre of music, a title of a movie, or an application, among others. The user may also enter other search-related parameters as the keywords using the peer search manager 126. For example, the user nay establish sets of keywords to be saved, locations or times at which particular keywords or sets of keywords should be broadcast, proximity-related parameters for the control of broadcasting the keywords, access lists for which peer devices to communicate with (or not communicate with), as well as any other types of parameters.

Once the user has entered the keywords 206, the peer search manager 126 provides the keywords to the peer communication manager 128 that can then broadcast the keywords as a broadcast message 210 over a broadcast communication link 212 using a communication transceiver 116. In implementations, the peer communication manager can insert a control message into a basic broadcast message 210 to broadcast the keywords 206. The control message can include various data fields, such as a message length, a message type, a number of parameters in the control message, and/or a list of the parameters that includes the keywords and a length for each keyword. The message type in a control message can be set to indicate that the control message is a request for a keyword search, the keywords are inserted in the control message, and the remaining fields of the control message can then be set appropriately for the keywords that are included in the control message.

At the peer device 204, the broadcast message 210 that includes the control message with the keywords 206 is received through a communication transceiver 116 by the peer communication manager 128. The peer communication manager 128 can then extract the keywords from the control message and send a request 214 to the peer data manager 130 that is implemented to search the shareable content 124 using the received keywords. The peer data manager 130 can search the shareable content 124 over an interface 216 to determine whether any of the content items 208 in the shareable content 124 match, correspond, or are related to the keywords. If related content items are found in the shareable content 124, the peer data manager 130 can generate metadata 218 describing the content items that are related to the keywords.

The peer communication manager 128 implemented by the peer device 204 can then establish a communication link 220 with the peer communication manager 128 at the requesting device 202 via which to communicate search results of the shareable content 124 based on the received keywords 206. If content items 208 of the shareable content are determined to be related to the received keywords, the search results can be communicated to the requesting device 202 as the metadata 218 that describes the related content items in the shareable content. Alternatively, the search results can be communicated to the requesting device 202 as a message that indicates there were no matches to the keywords found in the shareable content 124.

For example, if the peer data manager 130 at the peer device 204 finds content items 208 in the shareable content 124 that are related to the keywords 206, then the peer device 204 sends back a response to the control message from the requesting device 202 in the format of the control message, as described above, with a message type set to indicate that there is metadata 218 available and the metadata is included in the control message. If the peer data manager 130 does not find related content items, then the peer device 204 sends the response control message back to the requesting device with the message type set to indicate that there was no content items related to the received keywords.

When the requesting device 202 receives the control message indicating that the metadata 218 is available from the peer device 204, a user of the requesting device can initiate a request for any of the content items 208 that are represented by the metadata. Alternatively or in addition, the requesting device 202 can be implemented to automatically request one or more of the content items from the peer device. A request for the content items can then be communicated from the requesting device 202 to the peer device 204 over the established communication link 220 and the requested content (e.g., from the shareable content 124) can then be communicated from the peer device 204 to the requesting device 202 via the communication link 220.

In this example, the peer device 204 may represent multiple peer devices that have received the broadcast of the keywords 206 from the requesting device 202 over a broadcast communication link. Thus, the broadcast of the keywords from the requesting device can be effective to start the search for related content items in the shareable content 124 of multiple, different peer devices, such as the peer device 204. The user of the requesting device may then be presented with metadata from multiple, different ones of the peer devices, and the user can select content from one or more of the peer devices that respond to the keyword request, such as based on whatever criteria the user deems desirable. For example, a user may select a known peer device that belongs to another user who is commonly in proximity to the user, a peer device belonging to a person known to the user, or a peer device with superior signal strength and/or throughput compared to other peer devices.

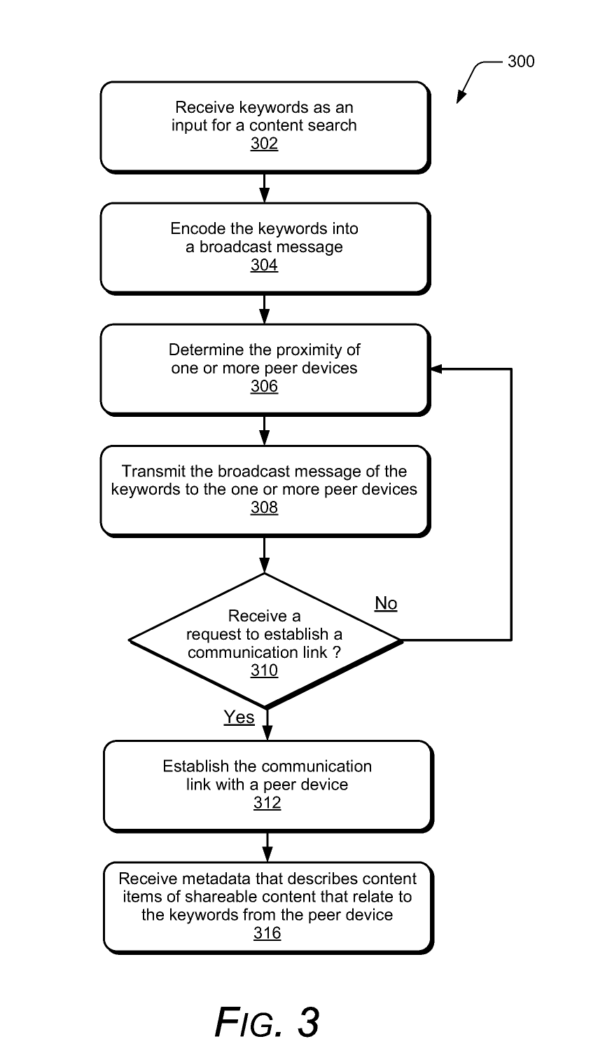

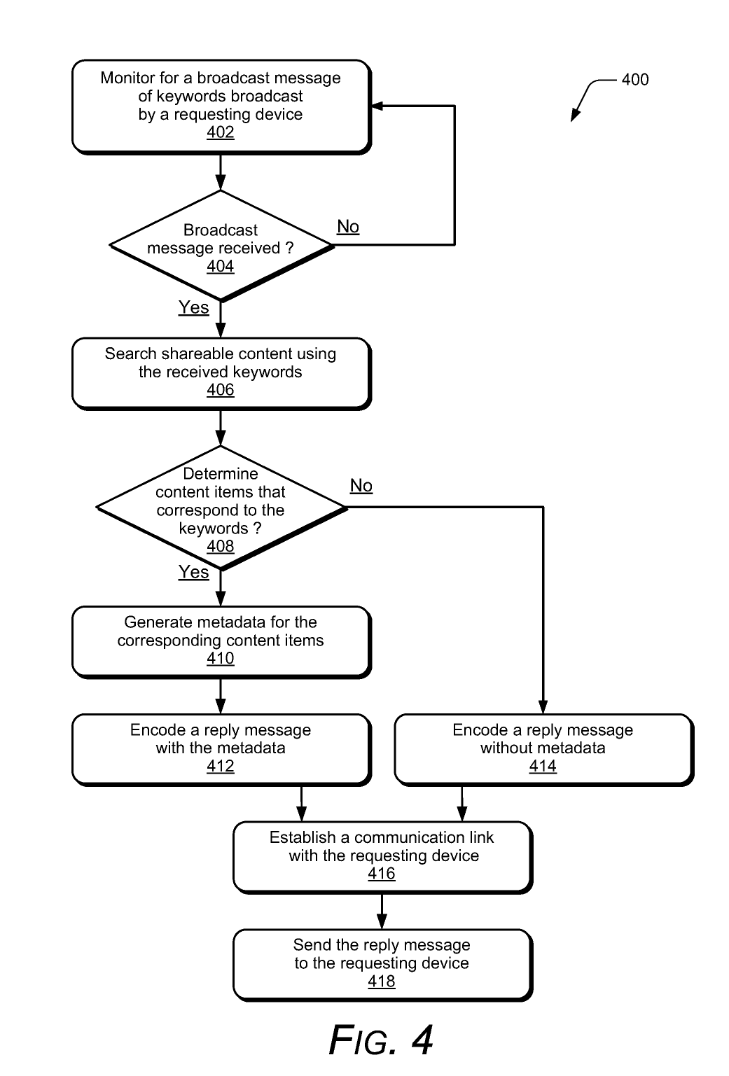

Example methods 300 and 400 are described with reference to respective FIGS. 3 and 4 in accordance with implementations of data query of a peer device. Generally, any of the services, components, modules, methods, and operations described herein can be implemented using software, firmware, hardware (e.g., fixed logic circuitry), manual processing, or any combination thereof. The example methods may be described in the general context of executable instructions stored on computer-readable storage media that is local and/or remote to a computer processing system, and implementations can include software applications, programs, functions, and the like.

FIG. 3 illustrates example method(s) 300 for data query of a peer device and is generally described with reference to a requesting device that broadcasts keywords to peer devices. The order in which the method is described is not intended to be construed as a limitation, and any number or combination of the described method operations can be performed in any order to perform a method, or an alternate method.

At 302, an input of keywords to search for content on peer devices is received. For example, the requesting device 202 (FIG. 2) implements the peer search manager 126 that receives an input of the keywords 206, and the keywords describe attributes of the content items 208 that a user of the requesting device would like to find. At 304, the received keywords are encoded into a broadcast message. For example, the peer communication manager 128 encodes the received keywords 206 into a broadcast message and inserts a control message into the broadcast message for broadcast of the keywords to peer devices that may have shareable content.

At 306, a determination is made that one or more peer devices are within proximity and, at 308, the broadcast message of the keywords is broadcast over a broadcast to the one or more peer devices. For example, the requesting device 202 can use various techniques to determine that the peer device 204 is within proximity of the requesting device 202, and the peer communication manager 128 at the requesting device 202 broadcasts the broadcast message 210 to the proximate peer devices. In implementations, the proximity of other peer devices may be determined in various ways, such as by geospatial location, membership in a common mesh network between the peer devices, or by any other technique utilized to determine proximate peer devices. If there are no peer devices in proximity to receive the broadcast message 210 the requesting device 202 can conserve power by not broadcasting the keywords in the broadcast message.

At 310, a request to establish a communication link is received from a peer device and, at 312, the communication link is established with the peer device. For example, in response to the peer device 204 receiving the broadcast message 210 from the requesting device 202, the peer communication manager 128 that is implemented by the peer device 204 sends a request to establish the communication link 220 between the peer device 204 and the requesting device 202, and the communication link is established between the devices by the respective peer communication managers (i.e., “Yes” from 310). Additionally, other peer devices may also respond to the requesting device 202 by requesting to establish a communication link with the requesting device. Alternatively, if a request to establish the communication link is not received from the peer device 204 (i.e., “No” from 310), then the requesting device 202 continues to determine the proximity of other peer devices at 306.

At 314, the metadata that describes the content items of the shareable content that are related to the keywords is received from the peer device. For example, the requesting device 202 receives the metadata 218 from the peer device 204, and the metadata describes the content items 208 of the shareable content 124 that are related to the keywords 206. The metadata 218 that is received at the requesting device 202 then enables the requesting device 202 to transmit a request to the peer device 204 requesting one or more of the content items 208 identified by the metadata. The peer device 204 can then return the requested content items to the requesting device 202 over the communication link 220.

FIG. 4 illustrates example method(s) 400 for data query of a peer device, and is generally described with reference to a peer device that receives keywords in a broadcast message from a requesting device. The order in which the method is described is not intended to be construed as a limitation, and any number or combination of the described method operations can be performed in any order to perform a method, or an alternate method.

At 402, a broadcast communication link is monitored to receive any broadcast message containing keywords to be used to search shareable content. For example, the peer device 204 (FIG. 2) implements the peer communication manager 128 that monitors the broadcast communication link 212 to receive the broadcast message 210 that includes the keywords 206 from the requesting device 202.

At 404, a determination is made as to whether a broadcast message is received from a requesting device. If no broadcast message is received (i.e., “No” from 404), then the peer communication manager 128 of the peer device 204 continues to monitor the broadcast communication link. 212 for broadcast messages at 402. If the broadcast message 210 is received from the requesting device. 202 (i.e., “Yes” from 404), then the broadcast message is decoded and the keywords are used to search the shareable content 124 that is maintained at the peer device.

At 406, the shareable content is searched using the received keywords. For example, the peer data manager 130 that is implemented by the peer device 204 uses the keywords 206 (e.g., received in the broadcast message 210) to search the shareable content 124 for content items 208 that are related the keywords. At 408, a determination is made as to whether content items that match, correspond, or are related to the keywords are found.

If content items 208 are determined to be related to the received keywords (i.e., “Yes” from 408), then at 410, metadata for the content items found in the shared content is generated. For example, the peer data manager 130 generates the metadata 218 for the related content items 208, and returns the generated metadata to the peer communication manager 128. At 412, a reply message is encoded to include the generated metadata. For example, the peer communication manager 128 at the peer device 204 encodes a reply message that includes the generated metadata 218.

Alternatively, if no related content items are found in the shareable content (i.e., “No” from 408), then the peer data manager 130 returns a reply to the peer communication manager 128 that no related content items 208 were found. At 414, a reply message is encoded without the metadata. For example, the peer communication manager 128 encodes the reply message to indicate, that no related content items were determined in the shareable content.

At 416, a communication link is established between the requesting device, and the peer device to communicate the reply control message from the peer device to the requesting device. For example, the peer communication manager 128 implemented by the peer device 204 transmits a request to the peer communication manager 128 implemented by the requesting device 202 to establish the communication link 220 between the peer device 204 and the requesting device 202. The requesting device 202 and the peer device 204 can then establish communications using the appropriate protocols for the transmission medium of the communication link 220.

At 418, the reply message, indicating whether or not there is related content items, is transmitted from the peer device to the requesting device. For example, the peer communication manager 128 at the peer device 204 initiates communication of the reply message to the requesting device 202 to indicate whether or not content items 208 related to the keywords 206 are determined from the shareable content 124 that is maintained by the peer device.

FIG. 5 illustrates various components of an example device 500 that can be implemented as any of the devices described with reference to any of the previous FIGS. 1-4. In embodiments, the example device may be implemented in any form of electronic and/or computing device, such as a fixed or mobile device, in any form of a consumer, computer, portable, user, communication, phone, navigation, gaming, messaging, Web browsing, paging, media playback, and/or other type of electronic device, such as the computing device 102 described with reference to FIG. 1.

The device 500 includes communication transceivers 502 that enable wired and/or wireless communication of device data 504, such as the keyword broadcasts, metadata, requests for content items, and/or other device data. Example transceivers include wireless personal area network (WPAN) radios compliant with various IEEE 802.15 (Bluetooth™) standards, wireless local area network (WEAN) radios compliant with any of the various IEEE 802.11 (WiFi™) standards, wireless wide area network (WWAN) radios for cellular telephony, wireless metropolitan area network (WMAN) radios compliant with various IEEE 802.15 (WiMAX™) standards, and wired local area network (LAN) Ethernet transceivers.

The device 500 may also include one or more data input ports 506 via which any type of data, media content, and/or inputs can be received, such as user-selectable inputs, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to components, peripherals, or accessories such as microphones and/or cameras.

The device 500 includes a processor system 508 of one or more processors (e.g., any of microprocessors, multi-core processors, controllers, and the like) and/or a processor and memory system (e.g., implemented in an SoC) that processes computer-executable instructions. The processor system can include a digital signal processing (DSP) subsystem for processing signals and data of the device. The processor system may be implemented at least partially in hardware, which can include components of an integrated circuit or on-chip system, an application-specific integrated circuit (ASIC), a field/programmable gate array (FPGA), a complex programmable logic device (CPLD), and other implementations in silicon and/or other hardware.

Alternatively or in addition, the device can be implemented with any one or combination of software, hardware, firmware, or fixed logic circuitry that is implemented in connection with processing and control circuits, which are generally identified at 510. Although not shown, the device can include a system bus or data transfer system that couples the various components within the device. A system bus can include, any one or combination of different bus structures, such as a memory bus or memory controller, a peripheral bus, a universal serial bus, and/or a processor or local bus that utilizes any of a variety of bus architectures.

The device 500 also includes one or more memory devices 512 that enable data storage, examples of which include random access memory (RAM), nonvolatile memory (e.g., read-only memory (ROM), flash memory, EPROM, EEPROM, etc), and a disk storage device. A disk storage device may be implemented as any type of magnetic or optical storage device, such as a hard disk drive, a recordable and/or rewriteable disc, any type of a digital versatile disc (DVD), and the like. The device 500 may also include a mass storage media device.

A memory device 512 provides data storage mechanisms to store the device data 504, other types of information and/or data, and various device applications 514 (e.g., software applications). For example, an operating system 516 can be maintained as software instructions with a memory device and executed by the processor system 508. The device applications may also include a device manager, such as any form of a control application, software application, signal-processing and control module, code that is native, to a particular device, a hardware abstraction layer for a particular device, and so on.

The device may also include a peer search manager 518, a peer communication manager 520, and/or a peer data manager 522 in embodiments for data query of a peer device, such as when the device 500 is implemented as any of the devices described, with reference to EEGs. 1-4. The peer search manager 518 is an example of the peer search manager 126, the peer communication manager 520 is an example of the peer communication manager 128, and the peer data manager 522 is an example of the peer data manger 130 that are described with reference to FIGS. 1-4.

The device 500 also includes an audio and/or video processing system 524 that generates audio data for an audio system 526 and/or generates display data for a display system 528. The audio system and/or the display system may include any devices that process, display, and/or otherwise render audio, video, display, and/or image data. Display data and audio signals can be communicated to an audio component and/or to a display component via an RF (radio frequency) link, video link, HDMI (high-definition multimedia interface), composite video link, component video link, DVI (digital video interface), analog audio connection, or other similar communication link, such as media data port 530. In implementations, the audio system and/or the display system are integrated components of the example device.

The device 500 can also include a power source 532, such as when the device is implemented as a mobile device. The power source May include a charging and/or power system, and can be implemented as a flexible strip battery a rechargeable battery, a charged super-capacitor, and/or any other type of active or passive power source.

Although embodiments of data (tam of a peer device have been described in language specific to features and/or methods, the subject attic appended claims is not necessarily limited to the specific features or methods described. Rather, the specific features and methods are disclosed as example implementations of data query of a peer device.

1. A peer device, comprising:
a memory configured to maintain shareable content that is stored on the peer device and designated as shareable;
a processor system to implement computer-executable instructions as a peer communication manager and a peer data manager:
the peer communication manager configured to receive keywords from a requesting device, the keywords entered as input to a peer search manager implemented by the requesting device and the keywords being usable to search for the shareable content related to the keywords; and
the peer data manager configured to determine the shareable content related to the keywords and generate metadata describing attributes of the shareable content.

2. The peer device as recited in claim 1, wherein the peer communication manager is configured to receive the keywords as a broadcast from the requesting device, the broadcast effective to enable reception of the keywords by one or more peer devices.

3. The peer device as recited in claim wherein the peer data manager is configured to extract the keywords from a control message received as a portion of the broadcast from the requesting device.

4. The peer device as recited in claim 1, wherein the peer data manager is configured to generate the metadata in response to the keywords received as a broadcast from the requesting device.

5. The peer device as recited in claim 4, wherein the peer data manager is configured to initiate communication of the generated metadata to the request ng device that broadcast the keywords.

6. The peer device as recited in claim 5, wherein the peer communication manager is configured to:
establish a communication link with the requesting device that broadcast the keywords; and
communicate the generated metadata to the requesting device responsive to the peer data manager that initiates the communication.

7. The peer device as recited in claim 6, wherein the peer communication manager is configured to:
receive a request for the shareable content from the requesting device based on the generated metadata; and
communicate the requested shareable content to the requesting device.

8. The peer device as recited in claim 1, wherein the peer device is a wired and/or wireless device further comprising at least one of:
a wired communication transceiver configured for wired communication with the requesting device; and
a wireless communication transceiver configured for wireless communication with the requesting device.

9. A method, comprising:
receiving keywords broadcast from a requesting device to one or more peer devices;
searching shareable content stored on a peer device using the received keywords;
determining content items of the shareable content that correspond to the keywords received from the requesting device;
generating metadata describing the content items; and
communicating the generated metadata from the peer device to the requesting device.

10. The method as recited in claim 9, further comprising:
establishing a communication link between the requesting device and the peer device for communication of the generated metadata.

11. The method as recited in claim 10, further comprising:
receiving a request for one or more of the content items described by the generated metadata; and
communicating the one or more content items from the peer device to the requesting device.

12. The method as recited in claim 10, wherein the communication link is one of a wireless communication link or a wired communication link.

13. The method as recited in claim 10, wherein the communication link is a peer-to-peer communication link implemented as a wireless mesh network.

14. The method as recited in claim 9, further comprising extracting the keywords from a control message received as a portion of the broadcast from the requesting device.

15. The method as recited in claim 9, farther comprising:
monitoring for a broadcast message to receive the keywords as the broadcast from the requesting device.

16. A system, comprising:
a requesting device that implements a first instance of a peer communication manager configured to broadcast keywords to one or more peer devices;
a peer device that implements a second instance of the peer communication manager and a peer data manager:
the peer data manager configured to determine shareable content that corresponds to the keywords received from the requesting device, the peer data manager further configured to generate metadata that describes the shareable content; and
the second instance, of the peer communication manager configured to establish a peer-to-peer communication link with the requesting device and communicate the generated metadata over the peer-to-peer communication link to the requesting device.

17. The system as recited in claim 16, wherein the second instance of the peer communication manager that is implemented at the peer device is configured to monitor for a broadcast message to receive the keywords broadcast by the first instance of the peer communication manager from the requesting device.

18. The system as recited in claim 17, wherein the peer-to-peer communication link is a wireless mesh network.

19. The system as recited in claim 17, wherein the second instance of the peer communication manager that is implemented at the peer device is configured to extract the keywords from a control message received as a portion of the broadcast device.

20. The system as recited in claim 16, wherein the second instance of the peer communication manager that is implemented by the peer device is configured to:
receive a request to send a content item of the shareable content that is identified in the metadata to the requesting device; and
communicate the requested content item to the requesting device.
